(19) United States
(12) Patent Application Publication
(10) Pub. No.: US 2008/0001703 A1
(43) Pub. Date: Jan. 3, 2008

(54) Portable electronic apparatus

(75) Inventor: Yoshihiro Goto, Hamura-shi (JP)

Correspondence Address: COHEN, PONTANI, LIEBERMAN & PAVANE, 551 FIFTH AVENUE, SUITE 1210, NEW YORK, NY, 10176, US

(73) Assignee: Casio Hitachi Mobile Communications Co., Ltd., Tokyo (JP)

(21) Appl. No.: 11/810,763

(22) Filed: Jun. 7, 2007

(30) Foreign Application Priority Data
Jun. 15, 2006 (JP) 2006-165741

(51) Int. Cl. G05B 19/00

(52) U.S. Cl. 340/5.8; 455/411; 382/124; 340/5.83; 340/5.74; 340/5.31

(57) ABSTRACT

Provided is a portable telephone apparatus which can change the arrangement (style) of its display portion and operation portion, and which makes it easy to input authentication information for making itself usable. A storage unit stores style lock association information that associates styles with authentication methods for making the portable telephone apparatus usable in these styles. A control unit determines whether or not terminal locking is imposed when the power is turned on. If the terminal locking is imposed, the control unit refers to the style lock association information and selects an authentication method associated with the current style detected by a style detection sensor. In a case where user authentication by the selected authentication method is successful, the control unit cancels the terminal locking and makes the portable telephone apparatus usable.

### BACKGROUND OF THE INVENTION

1. Field of the Invention

The present invention relates to a portable electronic apparatus having an authentication function.

2. Description of the Related Art

There is proposed a portable telephone apparatus which authenticates a user by using authentication information and allows the user to use it in a case where the authentication is successful. Portable telephone apparatuses of this type include one that can change the arrangement (hereinafter referred to as “style”) of its display portion and operation portion.

For example, Unexamined Japanese Patent Application KOKAI Publication No. 2001-217924 discloses a portable telephone apparatus which has an authentication function. This portable telephone apparatus is a foldable portable telephone apparatus whose display portion and operation portion can be opened up from and closed down to each other. This portable telephone apparatus authenticates a user based on a security code input from the operation portion.

This portable telephone apparatus has its display portion conceal its operation portion, when it is in a style that the display portion and the operation portion are folded. Therefore, in this folded style, the user cannot input his/her security code. Thus, the user has to restyle to open up the display portion and the operation portion when inputting the security code.

Unexamined Japanese Patent Application KOKAI Publication No. 2005-12425 discloses a portable telephone apparatus which has a fingerprint sensor. This portable telephone apparatus authenticates a user based on a fingerprint pattern read by the fingerprint sensor. According to the styles of this portable telephone apparatus, the direction in which the fingerprint sensor reads a fingerprint changes.

For example, in a case where the portable telephone apparatus is changed from the closed style to the open style, the reading direction of the fingerprint sensor as seen from the user gets reversed. Therefore, the user is likely to mistake the fingerprint reading direction. If the user inputs his/her fingerprint pattern with such a mistake about the reading direction, he/she fails in authentication. Thus, inputting of authentication information is troublesome.

Such a problem is not limited to a portable telephone apparatus, but likewise bothers various electronic apparatuses that can change their styles and require inputting of authentication information.

### SUMMARY OF THE INVENTION

The present invention was made in view of the above-described problem, and an object of the present invention is to provide a portable electronic apparatus which enables easy inputting of authentication information.

Another object of the present invention is to provide a portable electronic apparatus which allows inputting of authentication information with no need for a change of its current style.

To solve the above-described problem, a portable electronic apparatus according to the present invention is a portable electronic apparatus having a plurality of housings whose arrangement state can be changed, and comprises:

a plurality of authentication information input units which input authentication information;

an arrangement state detection unit which detects an arrangement state of the plurality of housings;

a use option storage unit which stores information that associates each of a plurality of arrangement states to be detected by the arrangement state detection unit with one or a plurality of the authentication information input units;

a selection unit which selects the authentication information input unit that is associated with the arrangement state detected by the arrangement state detection unit, based on a content stored in the use option storage unit;

an authentication unit which authenticates a user based on authentication information input by the authentication information input unit selected by the selection unit; and

a control unit which makes the portable electronic apparatus usable, in a case where authentication by the authentication unit ends in success.

To solve the above-described problem, there is further provided a recording medium which stores a program for controlling a computer to perform main functions of the present invention.

According to the present invention, when an authentication information input unit that is associated with the current arrangement state is selected and user authentication based on authentication information input by the authentication information input unit ends in success, the portable electronic apparatus becomes usable.

Therefore, authentication information for user authentication, which is performed for making the portable electronic apparatus usable, can easily be input with no need for changing the current arrangement state, which improves operability, sureness, and security.

### BRIEF DESCRIPTION OF THE DRAWINGS

These objects and other objects and advantages of the present invention will become more apparent upon reading of the following detailed description and the accompanying drawings in which:

FIG. 1A is an appearance diagram showing a normal open style (normal style) of a portable telephone apparatus;

FIG. 1B is an appearance diagram showing a reverse closed style (view style) of the portable telephone apparatus;

FIG. 1C is an appearance diagram showing a normal closed style of the portable telephone apparatus;

FIG. 2 is a block diagram showing the circuit structure of the portable telephone apparatus according to an embodiment of the present invention;

FIG. 3 is a diagram showing an example of the data structure of checking information;

FIG. 4 is a diagram showing an example of the data structure of authentication method selection information;

FIG. 5 is a diagram showing an example of the data structure of function selection information;

FIG. 6 is a diagram showing an example of the data structure of function restriction information;

FIG. 7 is a diagram showing an example of the data structure of authentication success/failure information;

FIG. 8 is a flowchart showing the entire operation of the portable telephone apparatus, which is started when the power is turned on;

FIG. 9 is a flowchart continuous from FIG. 8;

FIG. 10 is a flowchart continuous from FIG. 8;

FIG. 11 is a flowchart continuous from FIG. 8;

FIG. 12 is a flowchart showing a style-by-style checking process;

FIG. 13 is a flowchart continuous from FIG. 12; and

FIG. 14 is a flowchart continuous from FIG. 12.

### DETAILED DESCRIPTION OF THE PREFERRED EMBODIMENT

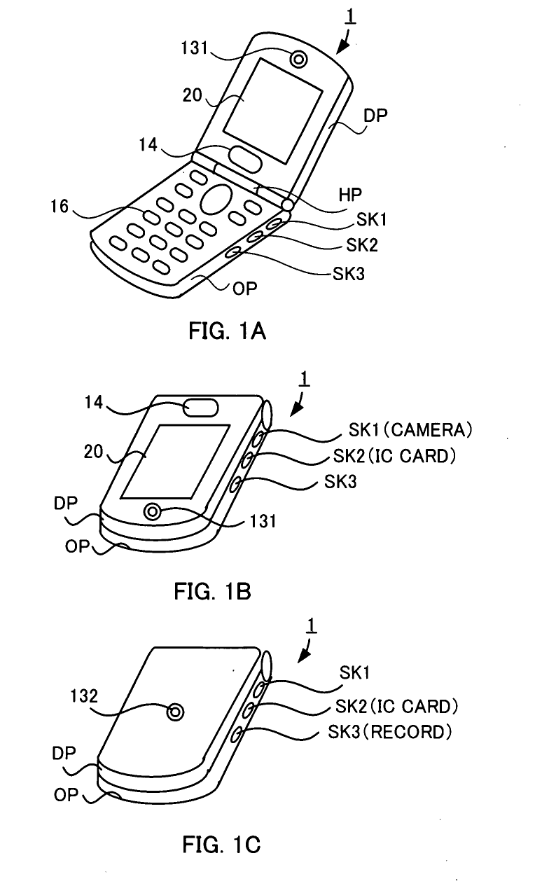

A portable telephone apparatus according to an embodiment of the present invention will be explained with reference to FIGS. 1 to 14.

The portable telephone apparatus 1 according to the present embodiment is capable of performing user authentication by three authentication methods, namely, password authentication, fingerprint authentication, and face authentication. The portable telephone apparatus 1 authenticates a user based on authentication information input, and permits the use thereof or the use of a predetermined function in response to a success of the authentication.

As shown in FIGS. 1A to 1C, the portable telephone apparatus 1 comprises a display portion DP, an operation portion OP, and a hinge portion HP which joins them together.

The display portion DP comprises a display panel 20, an in-camera 131, an out-camera 132, and a fingerprint sensor 14. The operation portion OP comprises a keyboard (input unit 16) on its principal surface, and a plurality of side keys SK1 to SK3 on its side surface. Each of these elements will be described in detail later.

The display portion DP and the operation portion OP can turn about the hinge portion HP, which serves as an axis of turn.

The portable telephone apparatus 1 can switch between an open state shown in FIG. 1A and a folded state shown in FIG. 1C where the display portion DP and the operation portion OP are laid fit on each other.

As shown in FIG. 1B and FIG. 1C, the display portion DP can be turned by 360 degrees, about an axis which is along the direction of its longer dimension. That is, the display portion DP can turn biaxially.

In this way, the portable telephone apparatus 1 can be changed to any one of four styles, namely i) a normal open style shown in FIG. 1A where the display portion DP and the operation portion OP are opened up with the display portion DP facing the normal direction, ii) a reverse open style where the display portion DP and the operation portion OP are opened up with the display portion DP turned by 180 degrees (reversed) from the style shown in FIG. 1A, iii) a normal closed style shown in FIG. 1C where the display portion DP and the operation portion OP are closed with the display portion DP facing the normal direction, and iv) a reverse closed style shown in FIG. 1B where the display portion DP and the operation portion OP are closed with the display portion DP reversed.

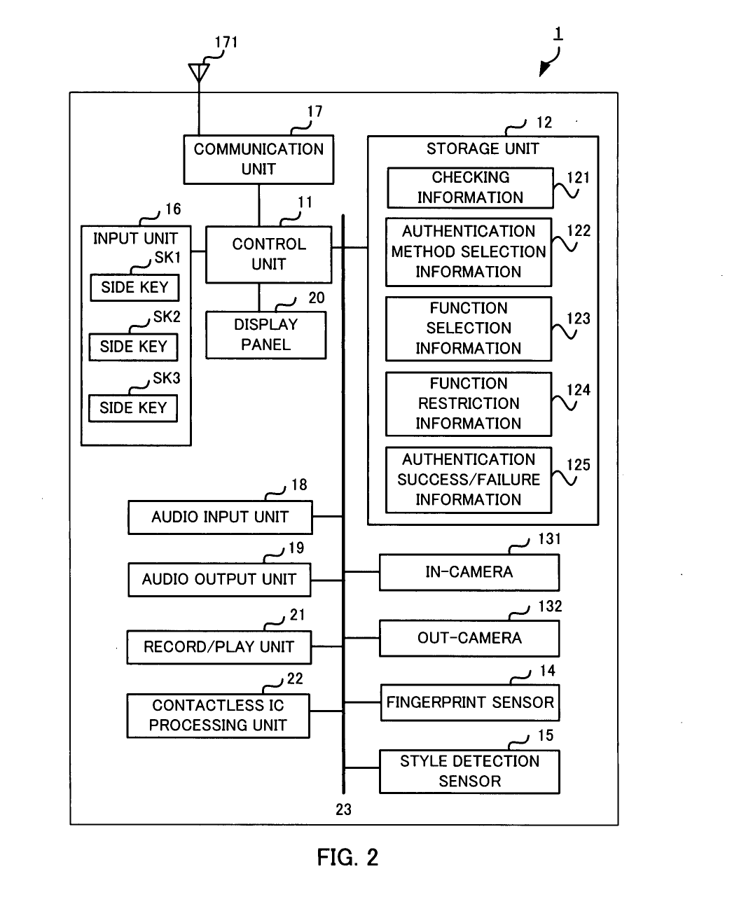

Next, the circuit structure of the portable telephone apparatus 1 will be explained with reference to FIG. 2.

As shown in FIG. 2, the portable telephone apparatus 1 comprises a control unit 11, a storage unit 12, an in-camera 131, an out-camera 132, a fingerprint sensor 14, a style detection sensor 15, an input unit 16, a communication unit 17, an audio input unit 18, an audio output unit 19, a display panel 20, a record/play unit 21, a contactless IC processing unit 22, and a bus 23.

The control unit 11 comprises a microprocessor unit or the like, and controls the entire operation of the portable telephone apparatus 1 according to an operation program stored in the storage unit 12.

For example, the control unit 11 stores fingerprint information showing a fingerprint pattern read by the fingerprint sensor 14 at the time of fingerprint setting and registration, in the storage unit 12.

The control unit 11 checks a fingerprint pattern read by the fingerprint sensor 14 against the fingerprint pattern shown by the fingerprint information stored in the storage unit 12, thereby authenticating a user.

Further, the control unit 11 checks a face image of a user shot by the in-camera 131 or the out-camera 132 (or face characteristic data acquired by analyzing the face image) against a face image (or face characteristic data) pre-stored in the storage unit 12 to authenticate a user.

The control unit 11 may comprise one microprocessor unit, or may comprise a main microprocessor and a plurality of sub-processors corresponding to the functions of data sending and receiving, video playing, etc. respectively.

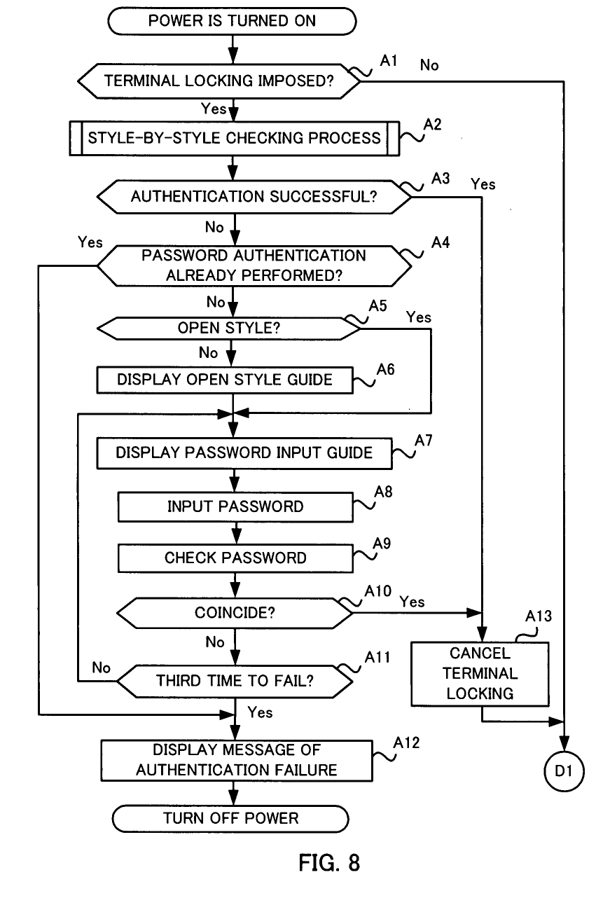

The storage unit 12 comprises a flash memory, a RAM (Random Access Memory), or the like, and stores programs, etc. for enabling the control unit 11 to perform the processes shown in FIGS. 8 to 14.

The storage unit 12 may comprise a built-in memory contained in the portable telephone apparatus 1, or a detachable external memory.

An external memory may comprise, for example, a smart medium, an IC card, or the like. An external memory supplies image data, data of various types, programs, etc. to the portable telephone apparatus 1 from the outside.

The storage unit 12 stores checking information 121, authentication method selection information 122, function selection information 123, a function restriction information 124, and authentication success/failure information 125.

The in-camera 131 and the out-camera 132 comprise, for example, a CCD (Charge Coupled Devices) camera, a CMOS sensor, etc., and pick up a still image or a moving image.

The in-camera 131 is attached above the display panel 20 of the display portion DP.

The out-camera 132 is attached to a surface of the display portion DP that is opposite to the surface where the display panel 20 exists.

The in-camera 131 and the out-camera 132 can both be used for user authentication.

The fingerprint sensor 14 comprises, for example, semiconductor contact sensors arranged in a matrix formation, and reads a fingerprint pattern of a finger put to contact its reading surface. Specifically, the fingerprint sensor 14 produces electric charge of a certain amount corresponding to the ridges and grooves of the fingerprint that contacts its reading surface, converts the amount of the produced electric charge into a voltage value, and transforms the voltage value into a digital image (fingerprint image data) and outputs it.

The style detection sensor 15 comprises a plurality of magnetic sensors, micro-switches, or the like, and is incorporated in the display portion DP and the operation portion OP. The style detection sensor 15 outputs a signal indicating whether the display portion DP and the operation portion OP are opened or closed, and a signal indicating whether the display portion DP is in a normal state or in a reversed state.

The control unit 11 integrates the signals output from the style detection sensor 15 and determines which of the above-described i) normal open style, ii) reverse open style, iii) normal closed style, and iv) reverse closed style the portable telephone terminal 1 is in.

The input unit 16 comprises a keyboard, a touch panel, etc., as shown in FIG. 1A, and outputs various instructions and data to the control unit 11 in response to inputs from the user.

For example, the user inputs a password from the input unit 16 for password authentication. The user can also turn on or off the power of the portable telephone terminal 1 by operating a power button provided on the input unit 16.

The input unit 16 further comprises side keys SK1, SK2, and SK3 as show in FIGS. 1A to 1C.

The side key SK1 is a key for turning on or off the in-camera 131 and the out-camera 132.

The side key SK2 is a key for turning on or off an electronic money processing function (IC card function) of the contactless IC processing unit 22.

The side key SK3 is a key for turning on or off the recording function of the record/play unit 21.

The communication unit 17 gains connection to a wireless or wired communication line through an antenna 171, and performs audio communication such as a phone call, or data communication such as an e-mail, web, etc. Further, the communication unit 171 comprises a modulation unit and a demodulation unit for modulating and demodulating data to be sent or received.

The audio input unit 18 comprises a mike, or the like, collects an audio input signal when a phone call is made or in a like occasion, converts the signal into an electric signal, and supplies it to the control unit 11.

The audio output unit 19 comprises a speaker or the like, converts an electric signal supplied from the control unit 11 when a phone call is made or in a like occasion into an analog audio signal, and outputs the signal.

The display panel 20 comprises a dot-matrix type LCD (Liquid Crystal Display) panel, a driver circuit, etc., and displays an image under the control of the control unit 11.

The record/play unit 21 records voices of a phone call, music, etc. in the storage unit 12, and reproduces and outputs the data stored in the storage unit 12. The control unit 11 gives an instruction to start or finish recording, and an instruction to start or finish reproducing, to the record/play unit 21, in response to instruction signals from the input unit 16.

The contactless IC (Integrated Circuit) processing unit 22 comprises a contactless IC card, a memory, a coil antenna, etc. When brought close to an external IC reader/writer (unillustrated), the contactless IC processing unit 22 exchanges data with the IC reader/writer by a weak radio wave.

The content of this data is, for example, information about electronic money processing (spending of e-money held, etc.). An external IC reader/writer performs processes like charging or withdrawing electronic money, etc.

The bus 23 transfers data between these elements described above.

Next, the styles of the portable telephone apparatus 1 will be explained in detail, with reference to again FIGS. 1A to 1C.

The normal open style (normal style) of FIG. 1A is an arrangement in which the display portion DP and the operation portion OP are opened up, and the input unit 16 and the display unit 20 are on the same plane.

Next, the reverse open style is an arrangement in which the display portion DP and the operation portion OP are opened up and the input unit 16 and the display panel 20 are on different planes from each other. The reverse open style is a state that appears when the display portion DP is turned by 180 degrees (reversed) from the normal open style of FIG. 1A about an axis along the direction of the longer dimension of the display portion DP.

Next, the reverse closed style (view style) of FIG. 1B is an arrangement in which the display portion DP and the operation portion OP are folded and laid on each other. At his time, the display panel 20, the in-camera 131, and the fingerprint sensor 14 are exposed outside, and the input unit 16 provided on the operation portion OP is hidden by the display portion DP.

Next, the normal closed style of FIG. 1C is an arrangement in which the display portion DP and the operation portion OP are folded and the display panel 20 faces the operation portion OP. In this normal closed style, the input unit 16, the in-camera 131, and the fingerprint sensor 14 are capsule enclosed inside, while the out-camera 132 is exposed outside.

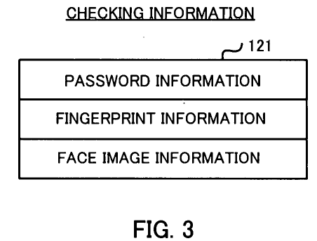

Next, with reference to FIG. 3 to FIG. 7, the checking information 121, the authentication method selection information 122, the function selection information 123, the function restriction information 124, and the authentication success/failure information 125, which are stored in the storage unit 12 will be explained.

First, the checking information 121 of FIG. 3 will be explained.

The checking information 121 is information for authenticating an authorized user of this portable telephone apparatus 1, and includes password information, fingerprint information, and face image information.

The password information is a string of characters and symbols registered through the input unit 16.

The fingerprint information is information showing a fingerprint pattern read by the fingerprint sensor 14 and registered by the control unit 11. The fingerprint information may be such information as specifying a characteristic of a fingerprint obtained through fingerprint pattern analysis, such as a center point, a branch point, an edge point, a delta, etc. of the fingerprint.

The face image information is information showing a face image shot by the in-camera 131 or the out-camera 132, and registered by the control unit 11. The face image information may be information that shows a face characteristic obtained through analysis of the face image.

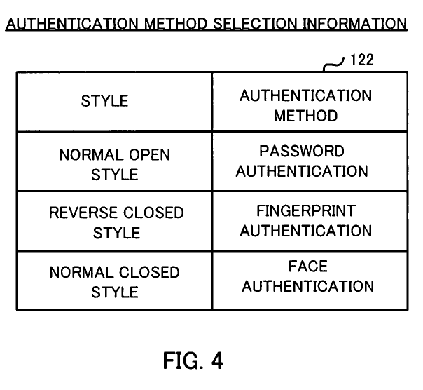

Next, the authentication method selection information 122 of FIG. 4 will be explained.

The authentication method selection information 122 associates the styles of the portable telephone apparatus 1 when it is to be turned on, with authentication methods used for canceling terminal locking. Terminal locking means restriction against the use of the portable telephone apparatus 1.

The authentication method selection information 122, for example, associates password authentication with the normal open style, fingerprint authentication with the reverse closed style, and face authentication with the normal closed style.

The association between the styles and the authentication methods may be arbitrarily set by the user.

In a case where the terminal locking is set, the control unit 11 refers to the authentication method selection information 122 and determines an authentication method that can cancel the terminal locking in the current style. Further, the control unit 11 authenticates the user according to the determined authentication method, and cancels the terminal locking if the authentication is successful.

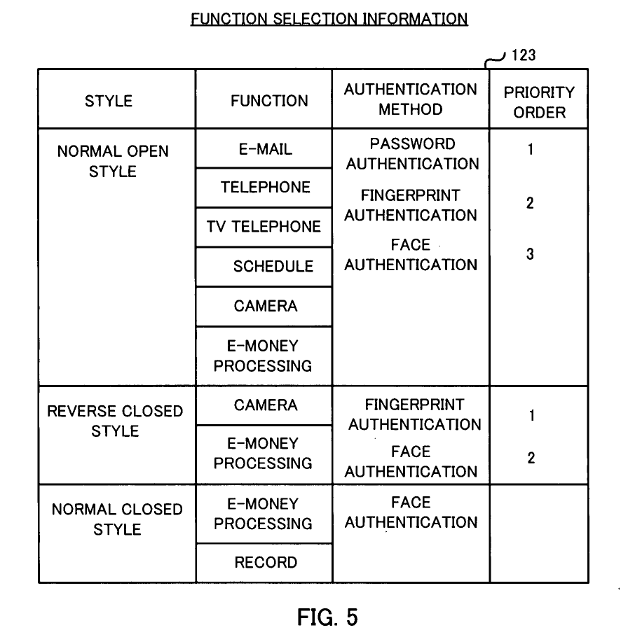

Next, the function selection information 123 of FIG. 5 will be explained.

The function selection information 123 associates each of the plurality of styles, options of functions that can be selected by the user in that style (hereinafter, such functions will be referred to as selection option functions), and an authentication method that enables the use of a function, among the selection option functions, that is restricted from being used.

The function selection information 123 can associate a plurality of selection option functions with each style.

For example, in the case of the normal open style, an e-mail function, a telephone function, a television telephone function, a schedule function, a camera function, and an electronic money processing function are the associated selection option functions.

In the case of the reverse closed style, the camera function and the electronic money processing function are the associated selection option functions. In this style, the input unit 16 of the operation portion OP is concealed by the display portion DP. Therefore, he side key SK1 is used to turn on or off the camera function, and the side key SK2 is used to turn on or off the electronic money processing function.

In the case of the normal closed style, the associated selection option functions are he electronic money processing function and the recording function. In this style, the input unit 16 of the operation portion OP is concealed by the display portion DP. Therefore, the side key SK2 is used to turn on or off the electronic money processing function, and the side key SK3 is used to turn on or off the recording function.

The function selection information 123 sets arbitrarily selected password authentication, fingerprint authentication, or face authentication in association with each style. A plurality of these authentication methods may be selected and set in association with one style.

For example, password authentication, fingerprint authentication, and face authentication are set as the authentication methods corresponding to the normal open style.

Fingerprint authentication and face authentication are set as the authentication methods corresponding to the reverse closed style. Face authentication is set as the authentication method corresponding to the normal closed style.

In a case where the function selection information 123 associates a plurality of authentication methods with one style, each of these authentication methods is given a priority order. The control unit 11 selects the authentication method according to the priority order.

For example, in the normal open style, the authentication method that is given the highest priority order (1) is password authentication.

The authentication method that is given the next highest priority order (2) is fingerprint authentication, and the authentication method that is given the lowest priority order (3) is face authentication.

In the reverse closed style, the authentication method that is given the highest priority order (1) is fingerprint authentication, and the authentication method given the lowest priority order (2) is face authentication.

In a case where user authentication by the authentication method selected according the priority order ends in fail, the control unit 11 determines whether or not there are authentication methods that are given lower priority orders. In a case where there are such methods, the control unit 11 selects one of these authentication methods that is given the highest priority order of them, and re-authenticates the user.

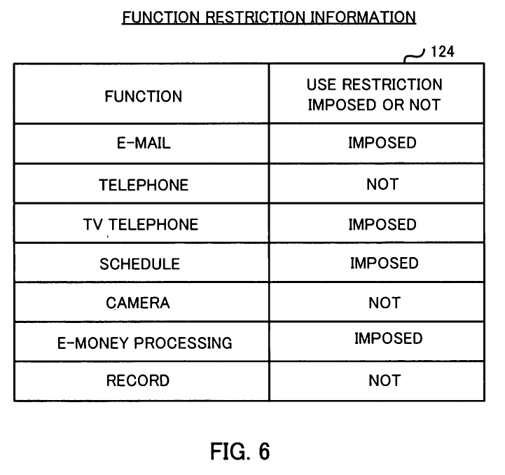

Next, the function restriction information 124 of FIG. 6 will be explained.

The function restriction information 124 associates each of a plurality of functions with whether the use of the function is restricted or not. If the item “use restriction imposed or not” indicates “imposed”, the function corresponding to the item is restricted from being used. If this item indicates “not”, the function corresponding to the item can be used.

For example, in FIG. 6, the use of the e-mail function, the television telephone function, the schedule function, and the electronic money processing function is restricted.

According to the present embodiment, the user can set restriction on each function against its use, or can set cancellation of the restriction. The user can make this setting by selecting an arbitrary selection from a function restriction setting screen, and selecting whether to restrict the use of the selected function or to cancel the restriction.

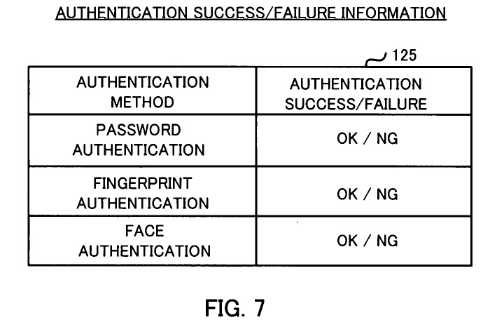

Next, the authentication success/failure information 125 of FIG. 7 will be explained.

The authentication success/failure information 125 is information that associates each of a plurality of authentication methods, with whether user authentication performed by using the authentication method ends in success or not (success (OK) or failure (NG)).

When the control unit 11 selects the authentication method associated with the current style and authenticates a user, the control unit 11 records whether the authentication by the selected authentication method ends in success or failure in the authentication success/failure information 125.

Hereinafter, the item “authentication success/failure” corresponding to password authentication will be-referred to as “password authentication success/failure flag”. The item “authentication success/failure” corresponding to fingerprint authentication will be referred to as “fingerprint authentication success/failure flag”. The item “authentication success/failure” corresponding to face authentication will be referred to as “face authentication success/failure flag”.

Next, with reference to the flowcharts shown in FIG. 8 to FIG. 14, the operation of the portable telephone apparatus 1 having the above-described structure will be explained.

First, with reference to FIG. 8 to FIG. 11, the general operation of the portable telephone apparatus 1 will be explained.

The process of the flow of FIG. 8 is activated when the user depresses the power button on the input unit 16 and the power of the portable telephone apparatus 1 is turned on.

When the power is turned on, the control unit 11 determines whether the terminal locking is imposed or not (FIG. 8, step A1).

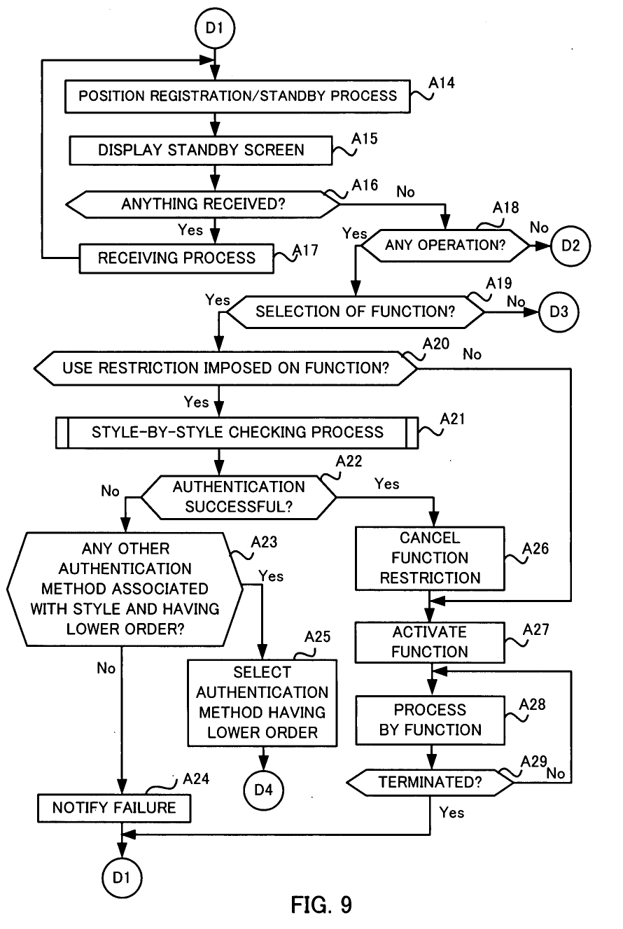

If the terminal locking is not imposed (step A1; No), the communication unit 17 performs a process of registering the current position and shifting to a standby state (FIG. 9, step A14).

The display panel 20 outputs a predetermined standby image (step A15), and the communication unit 17 determines whether or not any phone call or any e-mail is received (step A16).

If any phone call or e-mail is received (step A16; Yes), the audio output unit 19 notifies the reception by outputting a ringing melody or the like, and the communication unit 17 performs a process of receiving the incoming phone call or e-mail (step A17).

If neither phone call nor e-mail is received (step A16; No) but some kind of operation by the user is detected, (step A18; Yes), the control unit 11 determines whether or not the detected operation is an operation for selecting any function (step A19).

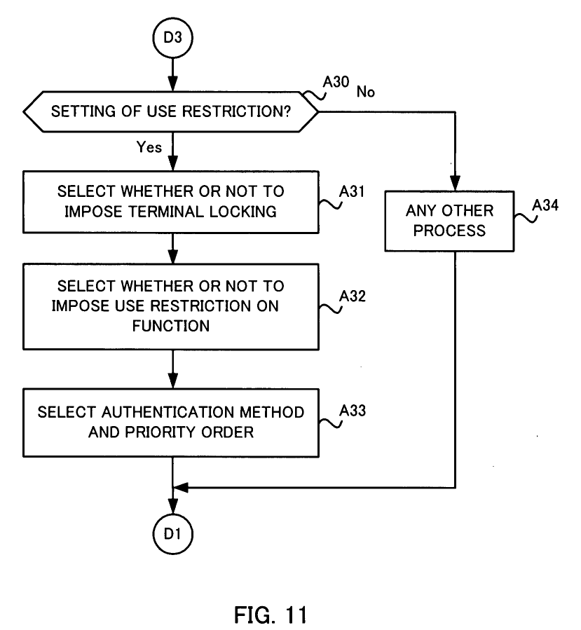

If it is not an operation for selecting a function (step A19; No), the control unit 11 determines whether or not the detected operation is an operation for setting use restriction (FIG. 11, step A30).

If it is not an operation for setting use restriction (step A30; No), the control unit 11 performs any other process that corresponds to the user operation (step A34).

Any other process is, for example, a phone call making process, an e-mail generating process, etc. Further, if the detected operation is an operation for registering checking information 121, the control unit 11 writes each information that is input in correspondence with any authentication method, in the checking information 121.

Meanwhile, if the detected operation is an operation for setting use restriction (step A30; Yes), the display panel 20 displays a setting operation screen for setting whether or not to impose the terminal locking.

When an instruction is given through the input unit 16 regarding either to impose the terminal locking or not, the control unit 11 sets either imposing the terminal locking or not imposing it, according to the instruction (step A31).

The user may be allowed to set the association between each style and the authentication methods for canceling the terminal locking in that style, and the association set by the user may be stored in the authentication method selection information 122.

When whether to impose the terminal locking or not is set, the display panel 20 displays a function restriction setting screen for setting whether or not to impose use restriction on each function.

When an instruction is given through the input unit 16 regarding either to impose use restriction or not, the control unit 11 sets either imposing use restriction on each function or not imposing it, in the function restriction information 124 (step A32).

Further, when an instruction about an authentication method is given through the input unit 16 regarding its correspondence to any style, the control unit 11 sets this authentication method correspondingly in the function selection information 123 according to the instruction (step A33).

At this time, if a plurality of authentication methods are input in correspondence with one style, a further instruction is given through the input unit 16 regarding the priority orders to be given to the respective authentication methods. In response to the instruction, the control unit 11 sets the authentication methods and the priority orders in association with each other in the function selection information 123.

After this, the portable telephone apparatus 1 shifts to the standby state (FIG. 9, step A14).

Meanwhile, in a case where the power of the portable telephone apparatus 1 is turned on and if the terminal locking is imposed (FIG. 8, step A1; Yes), the control unit 11 starts a style-by-style checking process (user authentication process) (step A2).

Further, in a case where neither phone call nor e-mail is received in the standby state (FIG. 9, step A16; No), and in a case where any user operation is detected (step A18; Yes), and if the operation is a function selecting operation (step A19; Yes), the control unit 11 determines whether or not use restriction is imposed on the selected function (step A20).

In a case where use restriction is not imposed (step A20; No), the control unit 11 activates the selected function (step A27).

In a case where use restriction is imposed (step A20; Yes), the control unit 11 performs a style-by-style checking process (step A21) to authenticate the user.

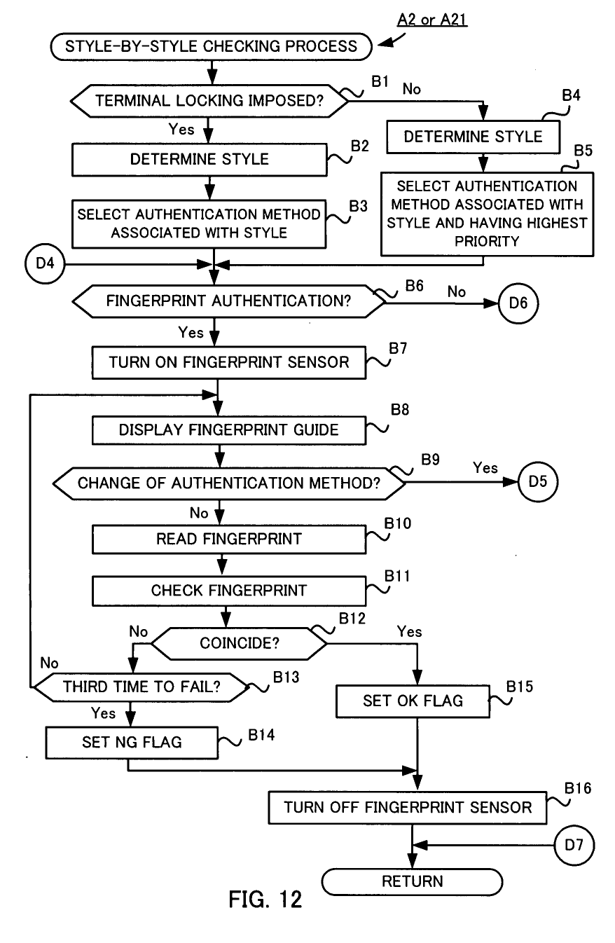

Hereafter, with reference to FIG. 12 to FIG. 14, the style-by-style checking process (step A2 of FIG. 8 or step A21 of FIG. 9) will be explained.

In the style-by-style checking process, the control unit 11 determines whether or not the terminal locking is currently imposed (FIG. 12, step B1).

In a case where the terminal locking is currently imposed (step B1; Yes), the control unit 11 determines the current style, based on a detection signal from the style detection sensor 15 (step B2). When the current style is determined, the control unit 11 refers to the authentication method selection information 122 and selects the authentication method associated with the current style (step B3).

On the other hand, in a case where the terminal locking is not imposed currently (step B1; No), the control unit 11 determines the current style (step B4). Further, the control unit 11 refers to the function selection information 123 and selects the authentication method that is given the highest priority order of the authentication methods associated with the current style (step B5).

The control unit 11 determines whether the authentication method selected at step B3 or step B5 is fingerprint authentication or not (step B6).

If it is fingerprint authentication (step B6; Yes), the control unit 11 turns on the fingerprint sensor 14 (step B7). The display panel 20 displays a guidance that prompts entry of fingerprint data (step B8).

The control unit 11 determines whether or not an operation for changing the authentication method is given (step B9).

If the fingerprint sensor 14 reads a fingerprint pattern and inputs the fingerprint information (step B10) before any operation for changing the authentication method is given (step B9; No), the control unit 11 checks the fingerprint information input by the fingerprint sensor 14 against the fingerprint information (step B11).

The control unit 11 determines whether or not the characteristics of both the fingerprint information coincide (step B12).

If they do not coincide (step B12; No), the control unit 11 determines whether or not this is the third time user authentication ends in failure (step B13).

Note that the user is allowed to give trials three times, because the fingerprint sensor 14 might not be able to properly read the fingerprint pattern due to a dirty finger, poor contact between the finger and the reading surface, etc.

If failures are less than three times (step B13; No), the control unit 11 returns the flow to step B8. The display panel 20 again displays the guidance that prompts entry of fingerprint information.

If user authentication failures reach three times (step B13; Yes), the control unit 11 sets the fingerprint authentication success/failure flag in the authentication success/failure information 125 to NG (step B14).

Meanwhile, if the fingerprint information read by the fingerprint sensor 14 and the fingerprint information stored coincide (step B12; Yes), the control unit 11 sets the fingerprint authentication success/failure flag in the authentication success/failure information 125 to OK (step B15).

After this, the control unit 11 turns off the fingerprint sensor 14 (step B16), and moves the flow to step A3 of FIG. 8 or step A22 of FIG. 9.

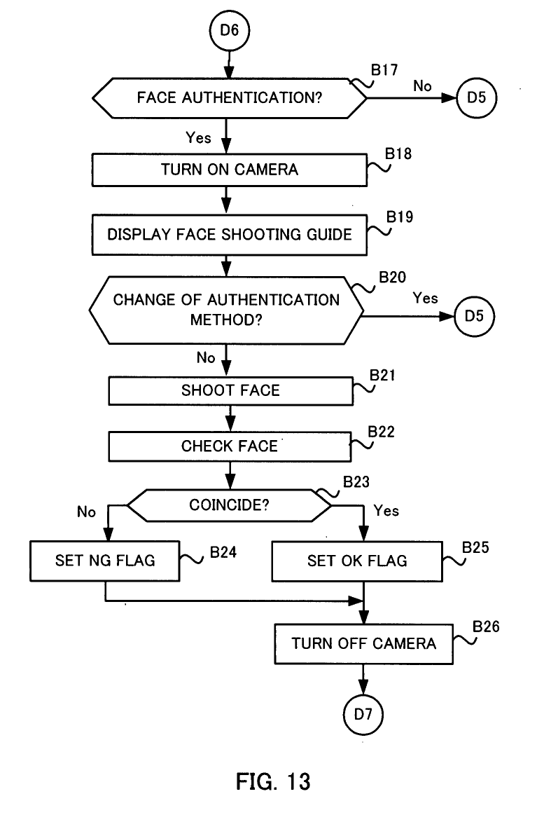

Next, with reference to FIG. 13, the process to be performed when it is determined in the style-by-style checking process that the authentication method is not fingerprint authentication (FIG. 12, step B6; No), will be explained.

In a case where it is determined that the authentication method is not fingerprint authentication (FIG. 12, step B6; No), the control unit 11 determines whether or not the authentication method is face authentication (FIG. 13, step B17).

If the selected authentication method is face authentication (step B17; Yes), the control unit 11 turns on either the in-camera 131 or the out-camera 132 according to the current style (step B18).

That is, if the current style is the normal open style or the view style where the in-camera 131 is exposed outside, the control unit 11 turns on the in-camera 131.

If the current style is the normal closed style where the out-camera 132 is exposed outside, the control unit 11 turns on the out-camera 132.

The display panel 20 displays a guidance to prompt the user to shoot his/her own face (step B19), and the control unit 11 determines whether or not an operation for changing the authentication method is given (step B20).

In a case where a face image is shot by the in-camera 131 or the out-camera 132 (step B21) before any operation for changing the authentication method is given (step B20; No), the control unit 11 checks the shot face image against the face image information (step B22).

The control unit 11 determines whether or not the characteristics of the shot face image and the characteristics shown by the face image information coincides with each other (step B23).

At this time, the control unit 11 not only compares the face lines, shape, position, and size of the eyes, mouth, and nose, the hair styles, whether eyeglasses are put on or not, etc., but also compares these things totally to determine whether the face characteristics coincide.

If the characteristics do not coincide (step B23; No), the control unit 11 sets the face authentication success/failure flag in the authentication success/failure information 125 to NG (step B24).

If they coincide (step B23; Yes), the control unit 11 sets the face authentication success/failure flag to OK (step B25).

After this, the control unit 11 turns off the in-camera 131 or the out-camera 132 that is now turned on (step B26), and moves the flow to step A3 of FIG. 8 or the step A22 of FIG. 9.

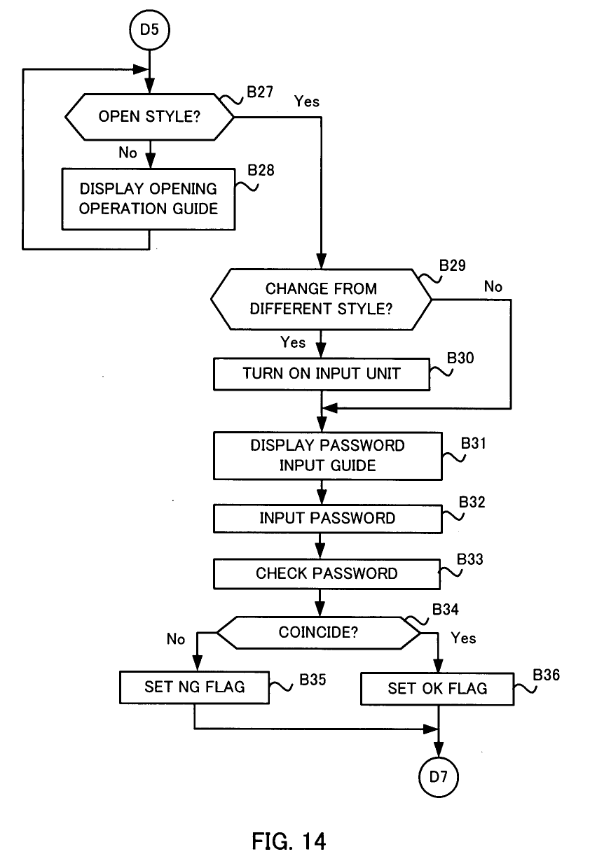

Meanwhile, if it is turned out, as a result of determination by the control unit 11, that the selected authentication method is password authentication (FIG. 13, step B17; No), the control unit 11 determines whether or not the current style is an open style (normal style) (FIG. 14, step B27).

If it is not an open style (step B27; No), the display panel 20 displays a guidance for prompting the user to change the style to an open style (step B28). The control unit 11 moves the flow to step B27, and waits for the style to be changed to an open style.

If the current style is an open style (step B27; Yes), and if this change is from a style other than an open style to this open style (step B29; Yes), the control unit 11 turns on the input unit 16 (step B30).

The display panel 20 displays a guidance for prompting the user to input a password (step B31).

When a password is input from the input unit 16 in accordance with the guidance (step B32), the control unit 11 checks the input password against the password information (step B33).

If they do not coincide as the result of the check (step B34; No), the control unit 11 sets the password authentication success/failure flag in the authentication success/failure information 125 to NG (step B35).

If the input password and the password information coincide (step B34; Yes), the control unit 11 sets the password authentication success/failure flag in the authentication success/failure information 125 to OK (step B36).

After this, the control unit 11 moves the flow to step A3 of FIG. 8 or step A22 of FIG. 9.

In a case where the authentication method is changed while fingerprint authentication is being selected (FIG. 12, step B9; Yes), the control unit 11 changes the authentication method from fingerprint authentication to password authentication (FIG. 14, steps B27 to B36).

In a case where the authentication method is changed while face authentication is being selected (FIG. 13, step B20; Yes), the control unit 11 also changes the authentication method from face authentication to password authentication (FIG. 14, steps B27 to B36).

That is, according to the present embodiment, the authentication method can be changed from fingerprint authentication to password authentication, or from face authentication to password authentication.

Next, the process after step A3 of FIG. 8 or step A22 of FIG. 9, which takes place after the style-by-style checking process (step A2 of FIG. 8 or step A21 of FIG. 9), will be explained.

First, the process to be performed after the control unit 11 moves the flow to step A3 after the style-by-style checking process (step A2 of FIG. 8), will be explained.

The control unit 11 determines whether or not the authentication ends in success, based on the authentication success/failure flag corresponding to the authentication method used in the style-by-style checking process (FIG. 8, step A3).

For example, assume that the terminal locking is imposed (step A1; Yes) and the style-by-style checking process (step A2) has been performed.

If, as a result, the authentication success/failure flag corresponding to the authentication method used for the user authentication indicates OK (step A3; Yes), the control unit 11 cancels the terminal locking (step A13), and performs the position registration/standby process (FIG. 9, step A14).

On the other hand, if the authentication success/failure flag corresponding to the authentication method used for the user authentication indicates NG (FIG. 8, step A3; No), the control unit 11 determines whether or not the user has been authenticated by password authentication in the style-by-style checking process (step A2) (step A4).

If password authentication has already been performed (step A4; Yes), the display panel 20 displays a message that cancellation of the terminal locking is unsuccessful (step A12), and the control unit 11 turns off the power of the portable telephone apparatus 1.

When password authentication has not yet been performed (step A4; No) is when user authentication by fingerprint authentication or by face authentication has ended in failure.

In this case, the control unit 11 determines whether or not the current style is an pen style (step A5).

If the current style is not an open style (step A5; No), the display panel 20 displays a guidance for changing the style to an open style (step A6).

If the current style is an open style (step A5; No), the display panel 20 displays a guidance that prompts entry of a password (step A7).

When the input unit 16 inputs a password in response to a user operation according o the guidance (step A8), the control unit 11 checks the input password against the password indicated by the password information (step A9).

If the input password and the password indicated by the password information do not coincide (step A10; No), the control unit 11 determines whether or not this is the third time when this user authentication ends in failure (step A11).

If this is the third time (step A11; Yes), the display panel 20 displays a message that cancellation of the terminal locking is unsuccessful (step A12), and the control unit 11 turns off the power of the portable telephone apparatus 1.

If failures are yet less than three times (step A11; No), the control unit 11 moves the flow to step A7, and the display panel 20 again displays a guidance that prompts entry of a password.

On the other hand, if the input password and the password indicated by the password information coincide (step A10; Yes), the control unit 11 cancels the terminal locking (step A13), and performs the position registration/standby process (FIG. 9, step A14).

Next, the process to be performed after the control unit 11 moves the flow to step A22 after the style-by-style checking process (FIG. 9, step A21), will be explained.

The control unit 11 determines whether or not the authentication has ended in success, based on the authentication success/failure flag corresponding to the authentication method used in the style-by-style checking process (FIG. 9, step A22).

For example, assume that the use of the selected function is restricted (step A20; Yes), and the style-by-style checking process (step A21) has been performed.

If, therefore, the authentication success/failure flag corresponding to the authentication method used for the user authentication indicates NG (step A22; No), the control unit 11 determines whether or not there is any authentication method which is associated with the current style and whose priority order is lower than that of the authentication method that has failed in authentication (step A23).

If there is no authentication method whose priority order is lower than that of the authentication method that has failed in authentication (step A23; No), the display panel 20 displays a message that cancellation of the use restriction on the selected function is unsuccessful (step A24).

After this, the control unit 11 performs the position registration/standby process (step A14).

If there is any authentication method whose priority order is lower than that of the authentication method that has failed in authentication (step A23; Yes), the control unit 11 selects the authentication method whose priority order is the highest of such methods (step A25).

The control unit 11 moves the flow to step B6 of FIG. 12, and performs user authentication by activating the structural element that is necessary for performing user authentication by the selected authentication method.

On the other hand, in a case where user authentication has ended in success by any authentication method in the style-by-style checking process (FIG. 9, step A22; Yes), the control unit 11 cancels the use restriction on the selected function (step A26).

After this, the control unit 11 activates the selected function (step A27), and performs any process by the selected function (step A28).

If there is an instruction to terminate the process by the selected function (step A29; Yes), the control unit 11 moves the flow to the position registration/standby process (step A14), and brings the portable telephone apparatus 1 into the standby state.

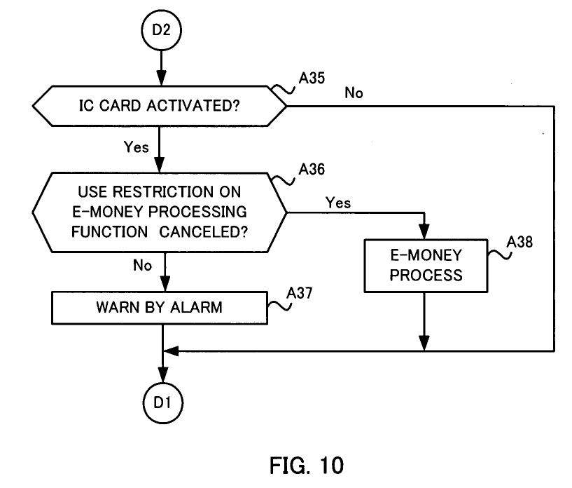

Next, with reference to FIG. 10, the process to be performed when the contactless IC processing unit 22 is activated when no phone call or e-mail is received or no user operation is given either in the standby state (FIG. 9, step A18; No), will be explained.

When the user holds the contactless IC processing unit 22 over an IC reader/writer to activate the contactless IC processing unit 22, the control unit 11 performs the process shown in FIG. 10.

The control unit 11 detects the activation of the contactless IC processing unit 22 (step A35; Yes), and determines whether or not use restriction on the electronic money processing function is canceled (step A36).

If use restriction is not canceled (step A36; No), the control unit 11 outputs an alarm sound to warn that the use of the electronic money processing function is restricted (step A37).

If use restriction on the electronic money processing function is canceled (step A36; Yes), the control unit 11 performs any electronic money process such as payment, etc. (step S38).

When the electronic money process is completed, the control unit 11 moves the flow to the position registration/standby process (FIG. 9, step A14) to bring the portable telephone apparatus 1 to the standby state.

As explained above, according to the present embodiment, the control unit 11 selects one authentication method from the authentication methods associated with the current style detected by the style detection sensor 15.

This facilitates entry of authentication information corresponding to any authentication method, which is selected from a plurality of authentication methods in correspondence with the current style, thereby improving operability and sureness.

According to the present embodiment, the control unit 11 cancels the terminal locking or cancels use restriction on a function, in a case where authentication by the selected authentication method is successful.

This makes it possible to authenticate the user based on authentication information that is input without changing the current style, and to cancel the terminal locking or cancel use restriction on a function in response to a success of the authentication.

According to the present embodiment, the portable telephone apparatus 1 can change the authentication methods style by style.

For example, in the reverse closed style, the user cannot input a password because he input unit is concealed by the display portion DP. In this case, the control unit 11 selects fingerprint authentication as the authentication method for authenticating the user.

Further, for example, in the open style, the user can input a password because the input unit 16 is exposed outside. In this case, the control unit 11 selects password authentication as the authentication method.

Therefore, operability, sureness, and security can be improved.

According to the present embodiment, the function selection information 123 associates a plurality of authentication methods with one style.

With reference to the function selection information 123, the control unit 11 can select any of a plurality of authentication methods associated with the style detected by the style detection sensor 15.

This enables switch of authentication methods in one style.

Further, in a case where there are a plurality of authentication methods that are associated with one style, each authentication method is given a priority order. The control unit 11 selects an authentication method according to the priority order, in a case where there are a plurality of authentication methods that are associated with the current style.

Therefore, in a case where the priority order is given in consideration of how easy the method is to use, recognition rate, security, etc., those authentication methods that are higher in operability, sureness, and security are selected in order.

According to the present embodiment, in a case where user authentication by the selected authentication method is unsuccessful, the control unit 11 determines whether or not there is any authentication method which is associated with the current style and whose priority order is lower than that of the selected authentication method.

In a case where there is any, the control unit 11 selects the authentication method whose priority order is the highest of such methods.

Therefore, for example, even if authentication by an authentication method selected from a plurality of authentication methods associated with the current style is unsuccessful, another authentication method, whose priority order is lower than that of the authentication method having failed in authentication, can be selected for the user to be authenticated again.

According to the present embodiment, when authenticating a user by selecting an authentication method from a plurality of authentication methods associated with the current style, the control unit 11 activates only the structural element that is necessary for the authentication information for the selected authentication method to be input.

This saves the electricity to be consumed by any structural element that needs not keep its capability of receiving input authentication information alive in the current style.

For example, the input unit 16, the fingerprint sensor 14, the in-camera 131, and the out-camera 132 do not need be always kept activated, but only the structural element that is necessary for inputting the authentication information for the authentication method associated with the current style.

Further, according to the present embodiment, when the control unit 11 selects an authentication method according to the current style, the display panel 20 displays a guidance corresponding to that authentication method.

This enables the user to easily understand which authentication information to input, in correspondence with the current style.

According to the present embodiment, when any function to be activated is selected from the input unit 16, the control unit 11 determines whether or not use of the selected unction is restricted.

If restricted, the control unit 11 selects the authentication method that is associated with the current style.

Further, in a case where the user authentication by the selected authentication method ends in success, the control unit 11 permits the use of the function whose activation is instructed. This makes it possible to free any function effective in any style from use restriction, by using the authentication method associated with the current style.

A modified example of the embodiment of the present invention will now be explained.

The authentication method selection information 122 may associate not only each style with any authentication method, but also each style with a key operation for canceling the terminal locking in that style. For example, in a case where to cancel the terminal locking in the normal open style, the user inputs a security code from the input unit 16.

In a case where to cancel the terminal locking in the reverse closed style, the user may depress the plurality of side keys SK1, SK2, and SK3, a predetermined number of times, in a predetermined order.

The authentication method selection information 122 may not necessarily set a plurality of methods in association with one style, but may associate styles and authentication methods in one-to-one correspondence.

The authentication method selection information 122 and the function selection information 123 may be prepared separately or may be prepared in one collectively.

Further, the fingerprint sensor 14 is not limited to a system that reads fingerprint data from the whole finger upon only once contact by the finger on the sensor surface (electrode surface), but may be a slide sensor that reads a fingerprint pattern from a finger which is slid in a predetermined direction (for example, up and down direction or left and right direction).

Use restriction may not only be the terminal locking or that that is imposed on any function, but may be that that is imposed on a data file such as a private address book file, a reception log file, a schedule book file, an image file, etc.

The authentication method for canceling the terminal locking or use restriction on any function is not limited to password authentication, fingerprint authentication, or face authentication, but may be biometric authentication based on biometric information such as iris, retina, vein, vocal print, etc.

The concept of the present invention can be applied not only to a computer system developed therefor, but to an arbitrary portable electronic apparatus that has a plurality of housings whose relative arrangement can be changed, such as a PDA, an electronic camera, an electronic wristwatch, a music player, etc.

That is, a computer program for enabling a computer to function and operate as the portable telephone apparatus 1 may be created, distributed, and rented and installed on a computer, so that the computer may be designed as the portable telephone apparatus 1, which may be used, given away, or rented.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2006-165741 filed on Jun. 15, 2006 and including specification, claims, drawings and summary. The disclosure of the above Japanese Patent Application is incorporated herein by reference in its entirety.

What is claimed is:

1. A portable electronic apparatus having a plurality of housings whose arrangement state can be changed, comprising:
a plurality of authentication information input units which input authentication information;
an arrangement state detection unit which detects an arrangement state of the plurality of housings;
a use option storage unit which stores information that associates each of a plurality of arrangement states to be detected by the arrangement state detection unit with one or a plurality of the authentication information input units;
a selection unit which selects the authentication information input unit that is associated with the arrangement state detected by the arrangement state detection unit, based on a content stored in the use option storage unit;
an authentication unit which authenticates a user based on authentication information input by the authentication information input unit selected by the selection unit; and
a control unit which makes the portable electronic apparatus usable, in a case where authentication by the authentication unit ends in success.

2. The portable electronic apparatus according to claim 1,
wherein the use option storage unit stores information that associates each of the plurality of arrangement states of the housings, with one or a plurality of the authentication information input unit(s) usable by the user in that arrangement state, or with one or a plurality of the authentication information input unit(s) which is/are exposed outside in that arrangement state.

3. The portable electronic apparatus according to claim 1,
wherein priority orders are given to the plurality of authentication information input units respectively,
in a case where there are a plurality of authentication information input units that are associated with the arrangement state detected by the arrangement state detection unit, the selection unit selects at least one authentication information input unit according to the priority orders given to the respective authentication information input units, and
the authentication unit authenticates the user based on authentication information input by the selected authentication information input unit.

4. The portable electronic apparatus according to claim 3,
wherein in a case where authentication by the authentication unit ends in failure:
the selection unit determines whether or not there is at least one authentication information input unit that is given a priority order lower than that of the authentication information input unit which has input the authentication information that has failed in the authentication, in the plurality of authentication information input units, and if there is any, selects the authentication information input unit whose priority order is highest of such units; and
the authentication unit again authenticates the user based on authentication information input by the selected authentication information input unit.

5. The portable electronic apparatus according to claim 1,
wherein the authentication information input units are stopped until selected by the selection unit, and
the portable electronic apparatus further comprises an activation unit which activates any authentication information input unit when this authentication information input unit is selected by the selection unit.

6. The portable electronic apparatus according to claim 1, further comprising
a display unit which displays operation information that shows an operation to be performed by the user in order for authentication information to be input by any of the authentication information input units,
wherein in a case where any of the authentication information input units is selected by the selection unit, the display unit displays operation information that corresponds to he selected authentication information input unit.

7. The portable electronic apparatus according to claim 1,
wherein the plurality of authentication information input units include:
a password input unit which is provided on the housing for inputting a password corresponding to an operation of the user; and
a fingerprint input unit which is provided on the housing different from the housing on which the password input unit is provided, for inputting a fingerprint pattern of the user,
the use option storage unit stores:
information that associates an arrangement state in which the password input unit is incapable of inputting a password, with the fingerprint input unit; and
information that associates an arrangement state in which the password input unit is capable of inputting a password, with the password input unit,
the selection unit:
determines whether or not the arrangement state detected by the arrangement state detection unit is the arrangement state in which the password input unit is capable of inputting a password, based on a content stored in the use option storage unit; and
selects the password input unit if it is the arrangement state in which the password input unit is capable of inputting a password, and selects the fingerprint input unit if it is the arrangement state in which the password input unit is incapable of inputting a password, and
the authentication unit authenticates the user based on a fingerprint pattern input by the fingerprint input unit selected by the selection unit, or a password input by the password input unit selected by the selection unit.

8. The portable electronic apparatus according to claim 1,
wherein the portable electronic apparatus has a plurality of functions each of which performs a predetermined operation, and further comprises:
a function storage unit which stores information that associates the plurality of arrangement states to be detected by the arrangement state detection unit, with one or a plurality of functions of the plurality of functions;
a function selection unit which selects at least one function from functions associated with the arrangement state detected by the arrangement state detection unit, based on a content stored in the function storage unit;
a restriction determining unit which determines whether or not use restriction is imposed on the function selected by the function selection unit; and
a function control unit which makes usable any function that is determined by the restriction determining unit as being imposed use restriction,
in a case where the restriction determining unit determines that use restriction is imposed, the selection unit selects the authentication information input unit that is associated with the arrangement state detected by the arrangement state detection unit,
the authentication unit authenticates the user based on authentication information input by the selected authentication information input unit, and
the function control unit makes usable the function selected by the function selection unit, in a case where authentication by the authentication unit ends in success.

9. A recording medium storing a program for controlling a computer which has:
a plurality of housings whose arrangement can be changed;
a plurality of authentication information input units which input authentication information;
a detection unit which detects an arrangement of the plurality of housings; and
a storage unit which stores information that associates an arrangement of the plurality of housings with the authentication information input unit usable by the user in that arrangement,
to perform:
a selecting step of selecting one or a plurality of the authentication information input unit(s), based on an arrangement detected by the detection unit and a content stored in the storage unit; and
an authenticating step of authenticating a user based on authentication information input by the authentication information input unit(s) selected in the selecting step.
